(19) United States
(12) Patent Application Publication
(10) Pub. No.: US 2008/0023430 A1
(43) Pub. Date: Jan. 31, 2008

(54) Lifter Provided with a Safety Stop

(76) Inventor: Kjell Andreasson, Arjang (SE)

Correspondence Address: NIXON & VANDERHYE, PC, 901 NORTH GLEBE ROAD, 11TH FLOOR, ARLINGTON, VA, 22203, US

(21) Appl. No.: 11/597,168

(22) PCT Filed: May 21, 2004
(86) PCT No.: PCT/SE04/00778

§ 371 Date: Dec. 11, 2006

(51) Int. Cl. B66D 3/18; F15B 15/26

(52) U.S. Cl. 212/271; 92/15

(57) ABSTRACT

The invention relates to a lifter, in particular a lifter for baggage. The lifter is provided with a safety stop that includes a pivotable stop element that pivots to a locking position when acceleration exceeds a limit value.

### TECHNICAL FIELD

The present invention relates to a lifting device comprising a flexible lifting element such as a rope, wire, or the like, which at one end may be provided with a gripping device for the object to be lifted, wherein the rope, wire, or the like, is connected to an actuator for pulling the flexible lifting element and lift the gripping device with adhering load upwards. Such lifting devices are used for instance at air ports to lift luggage but the invention is not limited to only this field of application.

### BACKGROUND OF THE INVENTION

Lifting devices for e.g. luggage at air ports are previously known and are used to a certain extent. Such devices facilitate the work in connection with the handling of luggage and are very appreciated by the personnel. A device of this kind typically comprises a handle with a hook at the bottom, which is connected to a wire. The wire is actuated by an actuator such as a pneumatic cylinder, which is provided in the ceiling; and through influence of the handle a user can control the hook so it is either lowered or raised. The lifting operation itself is performed by the hook, which is provided on an ergonomically shaped handle, and which is hooked in the handle of the suitcase, whereupon a pressure on one side of a control on the handle activates the pneumatic cylinder, so that the suitcase is lifted. The operator can then guide the suitcase to the desired position, whereupon he gets the suitcase to be lowered by pushing on the other side of the controller. The whole operation can be performed without any heavy lifts, i which results in a substantial reduction of diseases due to wear, which in its turn reduces the absence due to illness.

In a lifting device of the kind referred to above, there is a risk that unexpected accelerations occur. Such unexpected accelerations can occur if, for example, the wire, the handle or the hook breaks during the lifting operation. The wire can then be rapidly snatched upwards, before the air pressure in the cylinder stops the cylinder piston. Unexpected accelerations can also occur as a result of malfunction in pneumatic or hydraulic systems or as a result of luggage falling down from the hook. When the load is suddenly and unexpectedly removed from the lifter, the wire and other movable parts of the lifter may move very rapidly which can cause damage to the lifter. There is also a risk that the operator or other personnel close to the lifter may be injured by the wire. To solve the problem of unexpected acceleration, it has previously been proposed in WO 02/49955 that a lifter can be provided with a catch which is mounted in a means movable together with piston rods/cylinder pistons. The catch is arranged to move by inertia to a locking position the acceleration exceeds a predetermined value. It is an object of the present invention to provide an alternative safety device/safety stop that solves to the technical problem of preventing unexpected and harmful accelerations. It is also an object of the invention to provide a safety stop that can be easily installed on existing equipment at a low cost. These and other objectives are achieved by the invention that will be described in the following.

### SHORT DESCRIPTION OF THE INVENTION

The invention relates to a lifter comprising an elongate actuator with a shuttle arranged to be moved back and forth along the actuator. The lifter further comprises a safety stop. The safety stop comprises a first stop element that is elongate and fastened to the actuator adjacent the path of movement of the shuttle. The lifter also comprises a second stop element that is hingedly connected to the shuttle such that the second stop element may be pivoted/rotated relative to the shuttle. The second stop element is furthermore provided with a through-hole for the first stop element and the first stop element is passed through the through-hole of the second stop element such that acceleration of the shuttle above a maximum permissible value causes the second stop element to pivot. When the second stop element pivots, it will engage the first stop element, thereby counteracting further movement of the shuttle.

In preferred embodiments, the second stop element is arranged to abut against the shuttle when the shuttle is at rest or moves at a constant speed. Preferably, the second stop element is biased against the shuttle. The second stop element may be biased against the shuttle by a coil spring fastened at one end to a part of the shuttle and at the other end of the second stop element. However, other solutions are also possible. For example, a magnet could be used to bias the second stop element against a part of the shuffle.

The first stop element is preferably a wire fastened to the actuator at points spaced apart from each other along the path of movement of the shuttle. Preferably, this wire is fastened to the actuator at opposite ends of the actuator. Advantageously, at least one end of the wire is connected to a tensioning device such that the wire may be tensioned.

Suitably, the position of first stop element can be adjustable in a direction perpendicular to the longitudinal extension of the first stop element. One way of achieving this may be that, at spaced apart positions along the lifter, the lifter is provided with adjustable guides for the first stop element so that the position of the first stop element may be adjusted.

In preferred embodiments, the through-hole has openings that are bevelled. Preferably, the through-hole has a substantially circular cross section.

The shuttle may be operatively interconnected to a flexible lifting element such that movement of the shuttle causes the flexible lifting element to be either retracted into the lifter or to be fed out from the lifter. The flexible lifting element may be a cable and the lifter may comprise a number of pulleys around which the cable is drawn, one of the pulleys being journalled on the shuttle. In advantageous embodiments, the lifter comprises three pulleys of which two are journalled in stationary positions at opposite ends of the actuator and one is journalled on the shuttle.

Advantageously, the distance between the first stop element and an upper part of the inner wall of the through-hole is smaller than the distance between the first stop element and a lower part of the inner wall of the through-hole.

### BRIEF DESCRIPTION OF THE DRAWINGS

FIG. 1 shows a lifter being used by an operator.

FIG. 2 shows, in perspective, the interior of a part of the inventive lifter.

FIG. 3 is a side view of the lifter shown in FIG. 2 where a major part of the flexible lifting element has been retracted into the lifter.

FIG. 4 is a side view similar to FIG. 3 where a part of the flexible lifting element has been fed out from the lifter.

FIG. 5 is a side view similar to FIGS. 3 and 4 where the safety stop is shown more in detail.

FIG. 6 is a view similar to FIG. 5 where the safety stop has been activated to counteract further movement.

FIG. 7 shows a detail of the shuttle.

FIG. 8 shows another detail of the shuttle.

FIG. 9 shows the second stop element of the safety stop.

FIG. 10 is an exploded perspective view of the inventive lifter.

FIG. 11 is an enlargement of a part of FIG. 10 and shows a rear end of the lifter.

FIG. 12 is an enlargement of another part of FIG. 10 and shows a front end of the lifter.

FIG. 13 shows a guide for the first stop element.

FIG. 14 shows an alternative embodiment of a gripping device.

FIG. 15 shows a cross section of the second stop element.

FIG. 16 shows a front view of the stop element of FIG. 15.

FIG. 17 is a perspective view of an actuator that can be used for the lifter.

### DETAILED DESCRIPTION OF THE INVENTION

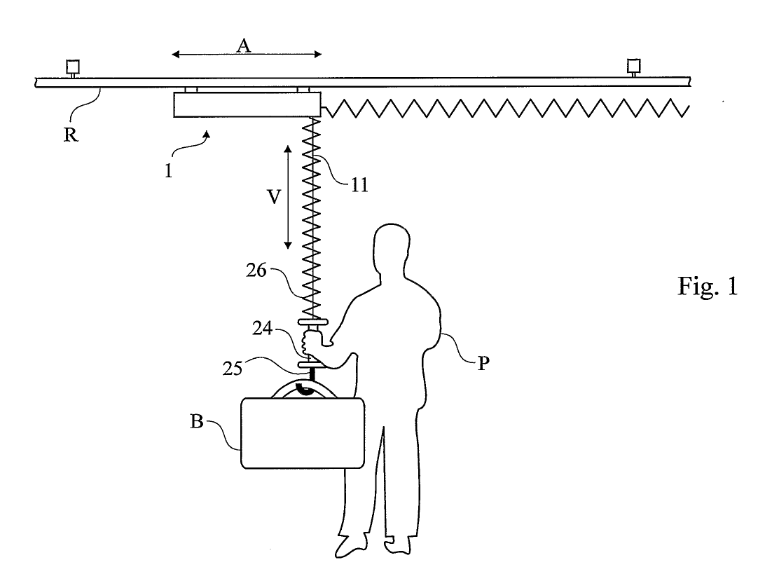

With reference to FIG. 1, a lifter 1 for objects such as baggage B is shown. An operator P uses the lifter 1 to move an object B, in particular a piece of luggage such as a suitcase B. The lifter 1 is horizontally movable along a rail R in the direction of arrow A. In FIG. 1, only a rail R for movement along one axis is shown. However, it should be understood that the lifter 1 may be a part of a system that comprises additional rails R that allow movement in a horizontal direction perpendicular to the direction of arrow A. For example, the rail R shown in FIG. 1 can be suspended on and slidable along such rails. The lifter 1 is provided with a flexible lifting element such as a rope or wire 11. The wire 11 can be fed out from the lifter 1 or pulled into the lifter 1. In FIG. 1, the end of the wire 11 is provided with a hook 25 that can be attached to the suitcase B. A handle 24 can include control means for the operator P that allow the operator P to control the lifter 1 to move a suitcase up or down in the vertical direction of arrow V. If the lifter 1 includes a pneumatic actuator, pressurized air may be passed through a flexible conduit 26 that is shown as forming a spiral around lifting wire 11 in FIG. 1.

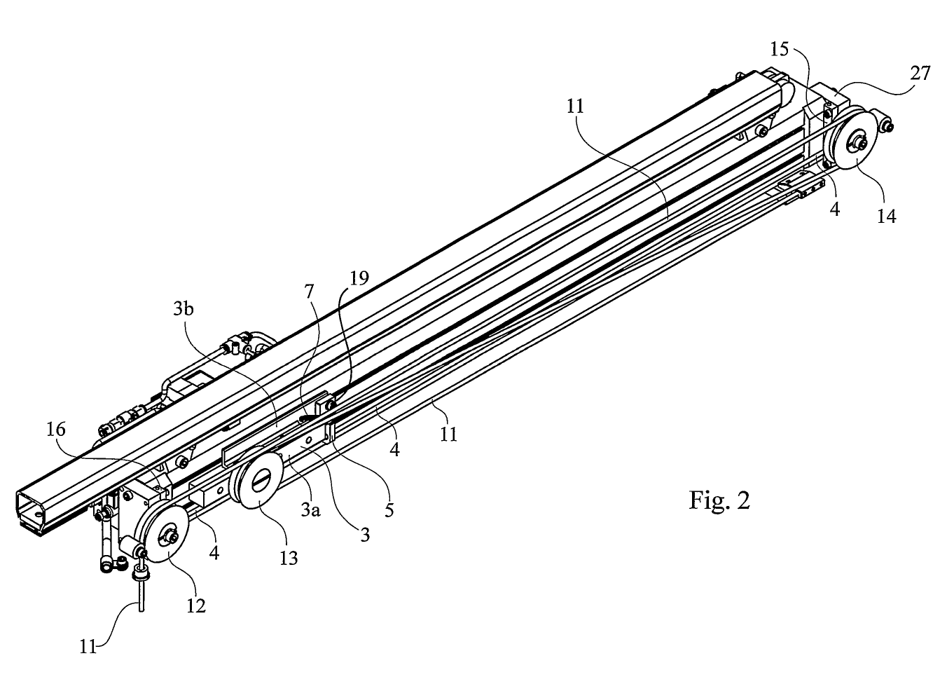

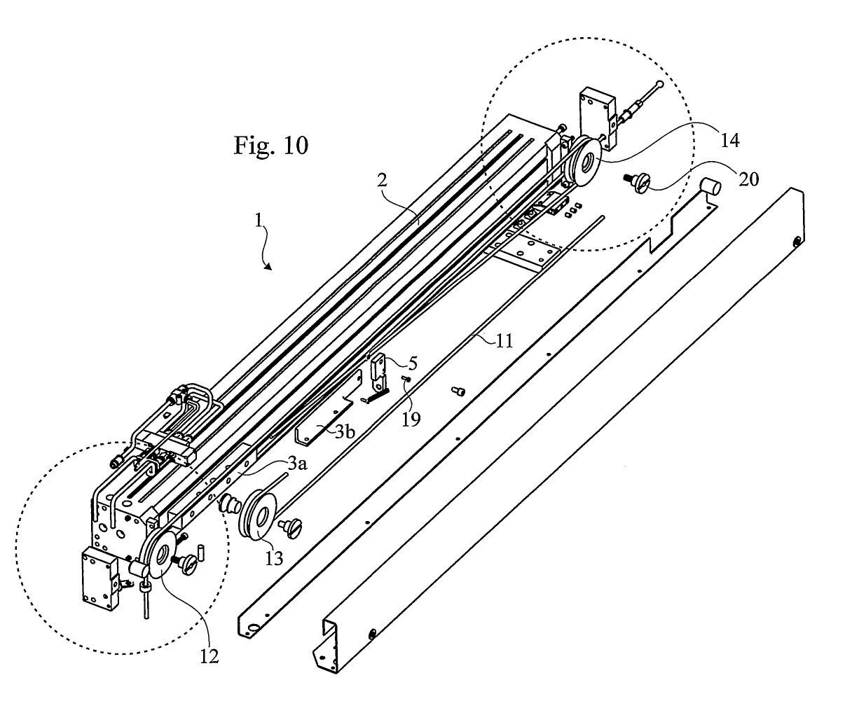

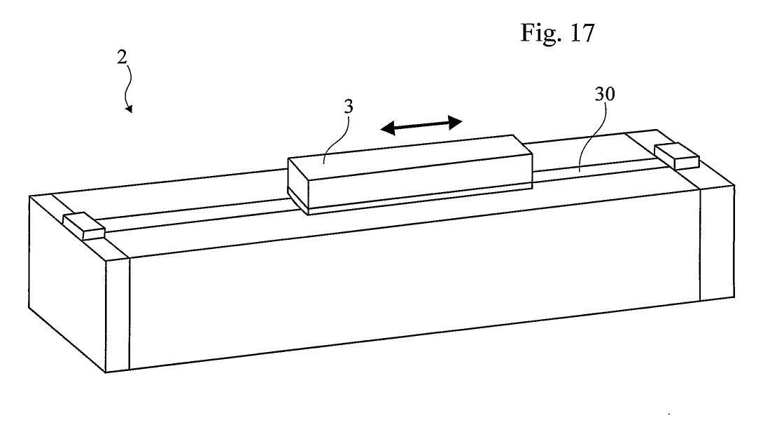

As can be seen in FIG. 2-4 and in FIG. 10, the lifter 1 comprises an elongate actuator 2. The elongate actuator 2 may be, for example, a pneumatic or hydraulic cylinder but other actuators could also be used. A particularly suitable pneumatic actuator is sold by Messrs. Festo AG & Co KG in Esslingen, Germany. This actuator is sold by Festo AG & Co KG under the designation “DGP-50-PPV-A-B” and is said to be a double-acting linear drive. In FIG. 2-4, it is showed that the actuator has a shuttle 3 arranged to be moved back and forth along the actuator 2. In the embodiment shown in the figures, the shuttle 3 has two components 3a, 3b that have been connected to each other (e.g. screwed together) but it should be understood that the shuttle 3 may be formed in one piece. The shuttle 3 can be acted on by means inside the elongate actuator 2 such that the shuttle 3 moves back and forth. The function of the actuator 2 as such does not form a part of the present invention and is therefore not explained in detail. In FIG. 17, a possible embodiment of an actuator 2 is shown. The actuator 2 shown in FIG. 17 has a shuttle 3 that is secured to a flexible steel strip 30 that can move back and forth. The steel strip 30 may be retracted into the interior of the actuator 2 at both ends of the strip 30. The exterior length of the steel strip is about the same as the length of the actuator 2. Inside the actuator 2, the strip 30 may be fixed to a piston (not shown) that can move inside the actuator 2. Movement of the piston will thus cause movement of the flexible strip 30 and thereby also the shuttle 3.

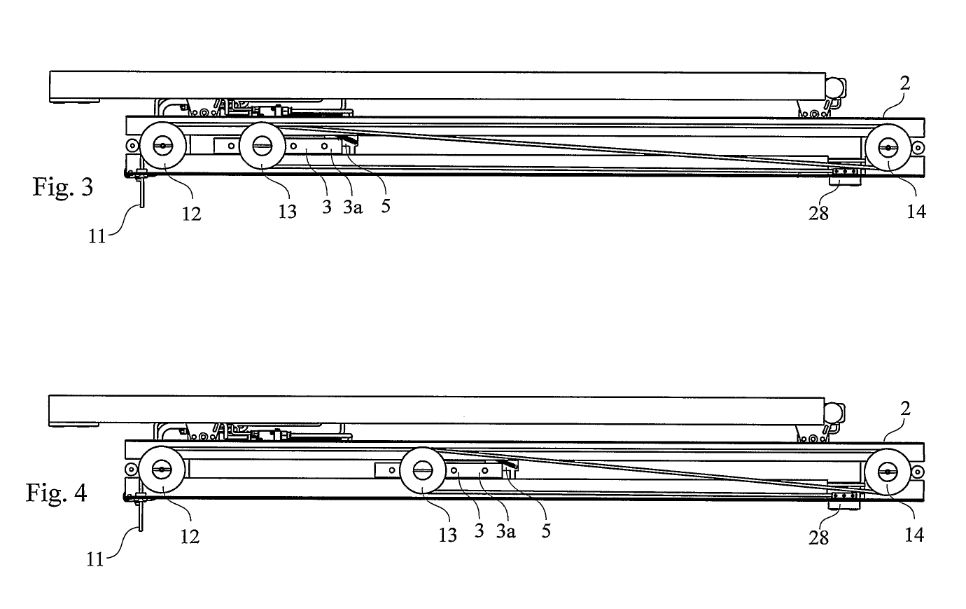

The function of the inventive lifter 1 will now be explained with reference to FIG. 3 and FIG. 4. The shuttle 3 is operatively interconnected to a flexible lifting element 11 such that movement of the shuttle 3 causes the flexible lifting element 11 to be either retracted into the lifter 1 or to be fed out from the lifter 1. The flexible lifting element 11 is a preferably a wire/cable 11. In the embodiment shown in FIG. 2 and FIG. 3, the lifter comprises three pulleys 12, 13, 14 around which the cable 11 is drawn. Two pulleys 12, 14 are journalled in stationary positions at opposite ends of the actuator 2. One pulley 13 is journalled on the movable shuttle 3. One end of the wire/cable 11 is fastened at a rear part 28 on the actuator 2. From the rear part 28, the cable 11 extends around the pulley 13 that is journalled on the movable shuttle 3 and from that pulley 13 to the pulley 14 that is journalled at the rear end of the actuator 2. The cable 11 is passed around the rear pulley 14 and from the rear pulley 14 to the front pulley 12 as indicated in FIG. 2, FIG. 3 and FIG. 4. In FIG. 4, the lifter is shown in a situation where the shuttle 3 is located between the ends of the actuator 2. When the lifter 1 is used to lift an object, the actuator 2 moves the shuttle 3 to the left such that the shuttle 3 moves toward the position shown in FIG. 3. This will cause the cable 11 to be retracted and an object attached to the end of the cable 11 will be lifted. The use of several pulleys 12, 13, 14 increases the available force.

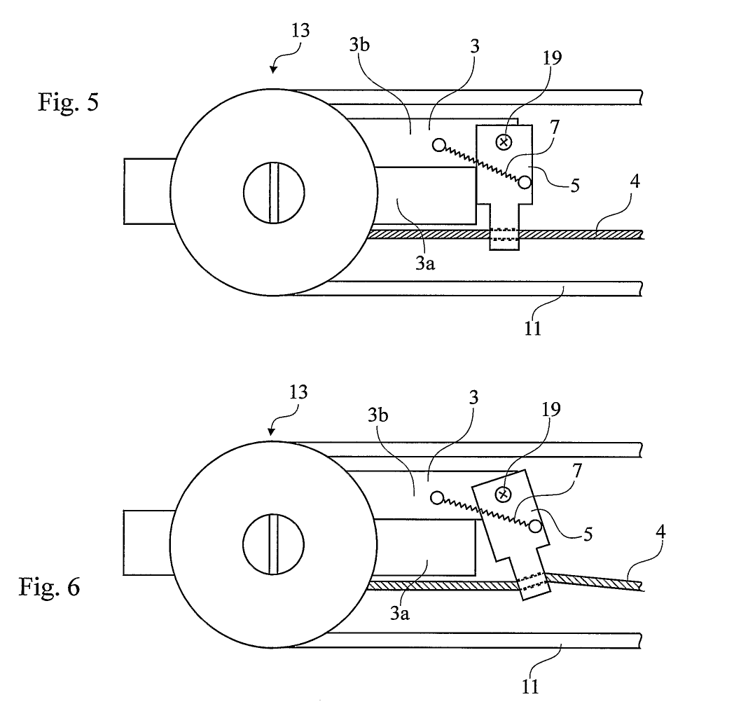

As best seen in FIG. 5 and FIG. 6, the lifter further comprises a safety stop. The safety stop comprises a first stop element 4 that is elongate and fastened to the actuator 2 adjacent the path of movement of the shuttle 3. The first stop element 4 may be a wire 4 fastened to the actuator 2 at points spaced apart from each other along the path of movement of the shuttle 3. In one embodiment that has been contemplated by the inventor, the wire 4 may have a diameter of about 5 mm and have 133 strands. The safety stop also comprises a second stop element 5 that is hingedly connected to the shuttle 3 such that the second stop element 5 may be pivoted relative to the shuttle 3. The second stop element S is shown in detail in FIG. 9, FIG. 15 and FIG. 16. The second stop element 5 is provided with a through-hole 6 for the first stop element 4. Preferably, the through-hole 6 has a substantially circular cross section. In advantageous embodiments of the invention, the through-hole 6 may have bevelled openings 9, 10. In FIG. 15 and FIG. 16, the second stop element 5 is shown as having a bearing formed by a hole 18 and a pin 19 so that the second stop element can be hingedly connected to the shuttle 3 when the pin 19 is passed through the hole 18 and secured to the shuffle 3. The first stop element 4 is passed through the through-hole 6 of the second stop element 5 such that acceleration of the shuttle 3 above a maximum permissible value causes the second stop element 5 to pivot and engage the first stop element 4, thereby counteracting or even preventing further movement of the shuttle 3. In FIG. 5, the shuttle 3 is stationary or moves at a constant speed. The second stop element 5 is arranged to abut against the shuttle 3 when the shuttle 3 is at rest or moves at a constant speed. In FIG. 5, it can be seen how the second stop element 5 is resting against a surface of the shuttle 3. Preferably, the second stop element 5 is biased against the shuttle 3. In FIG. 5, it is shown how the second stop element 5 is biased against the shuttle by a coil spring 7 fastened at one end to a part of the shuttle 3 and at the other end of the second stop element 5. The coil spring 7 is under tension and urges the second stop element 5 against the shuttle 3. The strength of the coil spring 7 affects the function of the safety stop. If the spring 7 is weak, the safety stop becomes more sensitive and reacts faster. Under normal conditions, the second stop element 5 will be pressed against the shuttle 3. The wire 4 will pass through the through-hole 6 without difficulty. However, in case of a sudden acceleration of the shuttle 3, the inertia of the second stop element 5 will cause it to pivot around the axis of the pin 19 to the position indicated in FIG. 6. In this position, the second stop element will interact with the wire 4 to counteract or prevent further movement. The wire 4 will be bent into a shape similar to the letter “z”. This will cause a very fast retardation of the movement of the shuttle.

In order to release the lifter 1, the operator P simply causes the actuator 2 to reverse its direction of movement. This can be done through control means in the handle 24. When the direction of movement of the actuator is reversed, the shuttle 3 will move to the right as seen in FIG. 6. This will cause the second stop element 5 to pivot/rotate back to the position indicated in FIG. 5.

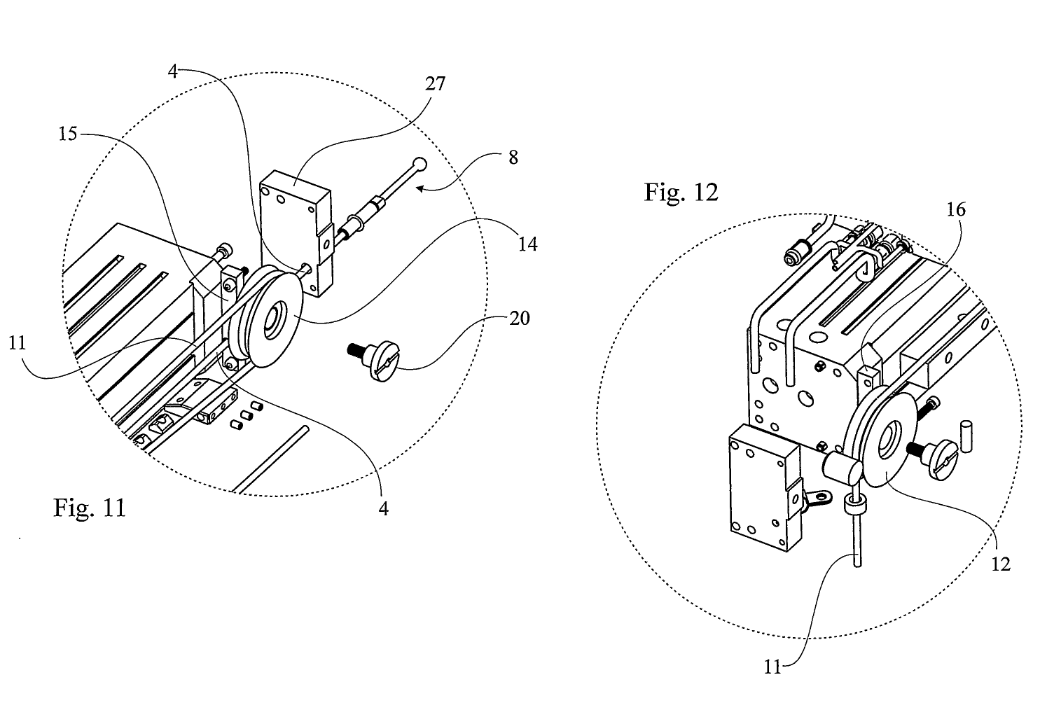

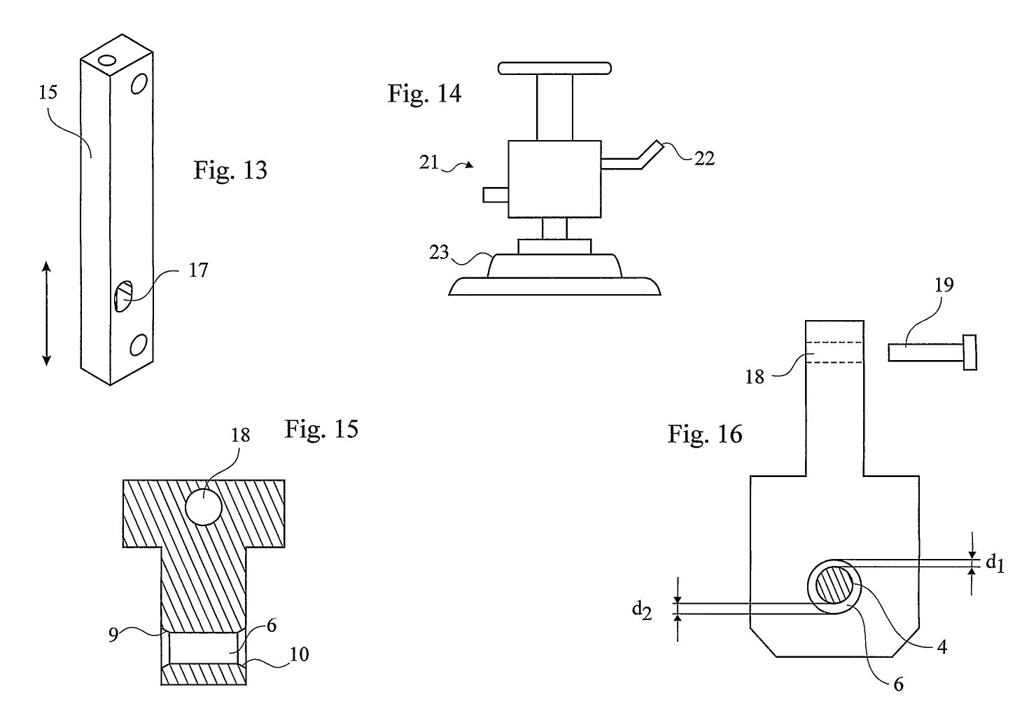

As indicated in FIG. 11, an end of the wire 4 may be passed through an end wall 27 of the actuator and connected to a tensioning device 8 such that the wire 4 may be tensioned.

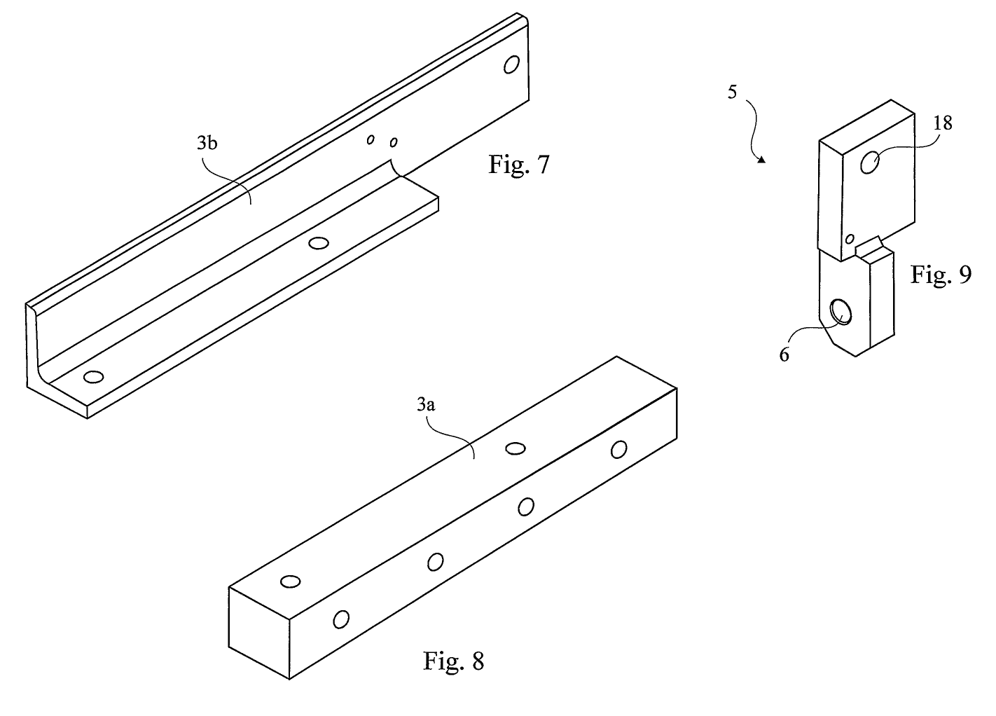

As indicated in FIG. 7 and FIG. 8, the shuttle 3 may be formed by two parts 3a, 3b. A first part 3a may be a part of the actuator 2 as it is delivered from the manufacturer of the actuator 2. The second part 3b may be a part with an L-shaped cross section that is screwed on top of the first part 3a or otherwise rigidly secured to the first part 3a.

In preferred embodiments of the invention, the position of first stop element 4 can be adjusted in a direction perpendicular to the longitudinal extension of the first stop element 4. As indicated in FIG. 11 and FIG. 12, the lifter may be provided with guides 15, 16 for the first stop element 4. The guides are placed at positions spaced apart along the lifter. Preferably, the guides 15, 16 are vertically adjustable so that the position of the first stop element 4 may be adjusted. The guides 15, 16 may be adjusted by means of screws (not shown). Each guide 15, 16 may have a through-hole 17 for the wire 4. As indicated in FIG. 16, there should be a slight play between the wire 4 and the walls of the through-hole 6 in the second stop element 5. The distance d₁ between the first stop element 4 and an upper part of the inner wall of the through-hole 6 should preferably be smaller than the distance d₂ between the first stop element 4 and a lower part of the inner wall of the through-hole 6. The reason is that, when the safety stop is activated, it is preferable that the upper part of through-hole 6 contacts the wire 4 before the lower part of the hole contacts the wire. Since the upper part of the through-hole 6 contacts the wire 4 at the front end of the through-hole 6, the movement will assist in causing the second stop element 5 to pivot.

If the openings 9, 10 are bevelled or otherwise made curved, stress on the wire 4 can be reduced.

The shuttle 3 preferably has a planar rear surface against which the second stop element 5 can abut. In preferred embodiments, the second stop element 5 has a corresponding planar surface.

The term shuttle as used herein should be understood as referring to any machine element arranged to perform a back-and-forth movement. It is thus possible to envisage embodiments where the shuttle has a form very different from the form presented in this application. For example, the flexible strip 30 shown in FIG. 17 can also be understood as a shuttle.

The hook 25 of FIG. 1 can be replaced by some other element 21. In FIG. 14, it is indicated how a gripping element 21 may comprise a suction cup 23 connected to a source of vacuum 22.

1. A lifter (1) comprising an elongate actuator (2) with a shuttle (3) arranged to be moved back and forth along the actuator (2), the lifter further comprising a safety stop, the safety stop comprising a first stop element (4) that is elongate and fastened to the actuator (2) adjacent the path of movement of the shuttle (3) and a second stop element (5) that is hingedly connected to the shuttle (3) such that the second stop element (5) may be pivoted relative to the shuttle (3), the second stop element (5) furthermore being provided with a through-hole (6) for the first stop element (4) and the first stop element (4) being passed through the through-hole (6) of the second stop element (5) such that acceleration of the shuttle (3) above a maximum permissible value causes the second stop element (5) to pivot and engage the first stop element (4), thereby counteracting further movement of the shuttle (3).

2. A lifter according to claim 1, wherein the second stop element (5) is arranged to abut against the shuttle (3) when the shuttle (3) is at rest or moves at a constant speed.

3. A lifter according to claim 2, wherein the second stop element (5) is biased against the shuttle (3).

4. A lifter according to claim 3, wherein the second stop element (5) is biased against the shuttle by a coil spring (7) fastened at one end to a part of the shuttle (3) and at the other end of the second stop element (5).

5. A lifter according to claim 1, wherein the first stop element (4) is a wire (4) fastened to the actuator (2) at points spaced apart from each other along the path of movement of the shuttle (3).

6. A lifter according to claim 5, wherein at least one end of the wire (4) is connected to a tensioning device (8) such that the wire (4) may be tensioned.

7. A lifter according to claim 6, wherein the position of first stop element (4) can be adjusted in a direction perpendicular to the longitudinal extension of the first stop element (4).

8. A lifter according to claim 1, wherein the through-hole (6) has bevelled openings (9, 10).

9. A lifter according to claim 8, wherein the through-hole (6) has a substantially circular cross section.

10. A lifter according to claim 1, wherein the shuttle (3) is operatively interconnected to a flexible lifting element (11) such that movement of the shuttle (3) causes the flexible lifting element (11) to be either retracted into the lifter (1) or to be fed out from the lifter (1).

11. A lifter according to claim 10, wherein the flexible lifting element (11) is a cable (11) and the lifter comprises a number of pulleys (12, 13, 14) around which the cable (11) is drawn, one of the pulleys being journalled on the shuttle (3).

12. A lifter according to claim 11, wherein the lifter comprises three pulleys (12, 13, 14) of which two are journalled in stationary positions at opposite ends of the actuator (2) and one is journalled on the shuttle (3).

13. A lifter according to claim 7, wherein, at spaced apart positions along the lifter, the lifter is provided with adjustable guides (15, 16) for the first stop element (4) so that the position of the first stop element (4) may thereby by adjusted.

14. A lifter according to claim 9 wherein the distance (d₁) between the first stop element (4) and an upper part of the inner wall of the through-hole (6) is smaller than the distance (d₂) between the first stop element (4) and a lower part of the inner wall of the through-hole (6).
